(19) United States
(12) Patent Application Publication
(10) Pub. No.: US 2021/0010389 A1
(43) Pub. Date: Jan. 14, 2021

(54) SHAFT VIBRATION MONITORING SYSTEM AND ROTARY MACHINE

(71) Applicant: MITSUBISHI HEAVY INDUSTRIES, LTD., Tokyo (JP)

(72) Inventor: Satoshi SABURI, Tokyo (JP)

(21) Appl. No.: 16/788,931

(22) Filed: Feb. 12, 2020

(30) Foreign Application Priority Data
Jul. 8, 2019 (JP) 2019-127020

(51) Int. Cl. F01D 21/00; G01H 1/00

(52) U.S. Cl. CPC F01D 21/003; G01H 1/006; F05D 2270/80; F05D 2260/80; F05D 2270/334

(57) ABSTRACT

A shaft vibration monitoring system is equipped with a plurality of sensors, a sensor abnormality determination unit, and a shaft vibration monitoring unit. The plurality of sensors detect vibration of the rotary shaft. The sensor abnormality determination unit is configured to compare the detection signals to be output from the plurality of sensors and determine whether an abnormality occurs in at least one of the plurality of sensors. The shaft vibration monitoring unit is configured to monitor the vibration of the rotary shaft, on the basis of the detection signals to be output from the plurality of sensors and the determination result of the sensor abnormality determination unit.

### BACKGROUND OF THE INVENTION

### Field of the Invention

The present invention relates to a shaft vibration monitoring system and a rotary machine.

Priority is claimed on Japanese Patent Application No. 2019-127020, filed Jul. 8, 2019, the content of which is incorporated herein by reference.

### Description of Related Art

The operating state of a rotary machine such as a turbine, a compressor or a pump is monitored by detecting a vibration state of a rotary shaft.

Patent Document 1 discloses a configuration in which a pair of sensors (probes) are provided at a position facing a guide bearing that supports a main shaft, and a vibration abnormality determination of the rotary shaft is performed on the basis of detection signals of the pair of sensors.

### PATENT DOCUMENTS

Patent Document 1: Japanese Unexamined Patent Application, First Publication No. H04-315016

### SUMMARY OF THE INVENTION

However, for example, when noise from a power supply system or the like is mixed or a sensor itself causes an abnormality, a detection signal from the sensor may be affected. In such cases, even when a vibration abnormality is detected in the detection result of the sensor, it is difficult for a user to determine whether the vibration abnormality actually occurs in the rotary shaft or an abnormality occurs in the sensor. Therefore, even when no abnormality actually occurs in the rotary machine, there is a problem that it is necessary to stop the operation and check each part, which leads to a decrease in an operating rate of the rotary machine.

The present invention has been made in view of the above circumstances, and an object thereof is to provide a shaft vibration monitoring system and a rotary machine that can enhance the operating rate of a rotary machine.

The present invention adopts the following means to solve the aforementioned problems.

According to a first aspect of the present invention, a shaft vibration monitoring system is a shaft vibration monitoring system of a rotary machine equipped with a rotary shaft and a bearing rotatably supporting the rotary shaft around an axis of the rotary shaft. The shaft vibration monitoring system includes a plurality of sensors, a sensor abnormality determination unit, and a shaft vibration monitoring unit. The plurality of sensors detect vibration of the rotary shaft. The sensor abnormality determination unit is configured to compare detection signals output from the plurality of sensors and determine whether an abnormality occurs in at least one of the plurality of sensors. The shaft vibration monitoring unit is configured to monitor vibration of the rotary shaft on the basis of detection signals output from the plurality of sensors and a determination result of the sensor abnormality determination unit.

The sensor abnormality determination unit of the first aspect compares detection signals which are output from a plurality of sensors. When a vibration occurs in the rotary shaft, although there are cases in which the magnitudes of vibrations to be detected differ among the plurality of sensors, the timings of the vibrations to be detected are synchronized. In contrast, when an abnormality occurs in at least one of the plurality of sensors, even if the detection signal from the sensor fluctuates due to the abnormality, the fluctuation in the detection signals does not exceed a certain level in other sensors. Therefore, if the detection signals from a plurality of sensors are compared, it is possible to detect whether an abnormality occurs in the sensors. Furthermore, since the vibration of the rotary shaft is monitored on the basis of the detection signal of the sensor and the determination result of the sensor abnormality determination unit, an abnormality such as an abnormal vibration can be prevented from being determined to occur in the rotary shaft due to an abnormality occurring in the sensor. As a result, there is no need to unnecessarily stop the operation of the rotary machine, and the operating rate of the rotary machine can be enhanced.

According to a second aspect of the present invention, the shaft vibration monitoring unit according to the first aspect may include a shaft vibration abnormality determination unit and a signal correction unit. The shaft vibration abnormality determination unit is configured to determine whether an abnormal vibration occurs in the rotary shaft on the basis of detection signals output from the plurality of sensors. The signal correction unit is configured to correct a detection signal of the sensor determined to abnormal when the sensor abnormality determination unit determines that an abnormality occurs in at least one of the plurality of sensors.

With such a configuration, since the detection signal of the sensor in which the abnormality occurs is corrected, the shaft vibration abnormality determination unit is prevented from being affected by the fluctuation in the detection signals due to abnormality of the sensor, and is prevented from erroneously determining that an abnormal vibration occurs in the rotary shaft.

According to a third aspect of the present invention, the signal correction unit according to the second aspect is configured to correct the detection signal of the sensor which is determined to be abnormal to be equal to or less than a reference value at which the shaft vibration abnormality determination unit determines that an abnormal vibration occurs in the rotary shaft.

With such a configuration, the shaft vibration abnormality determination unit is prevented from erroneously determining that an abnormal vibration occurs in the rotary shaft due to fluctuation in the detection signals caused by the abnormality of the sensor.

According to a fourth aspect of the present invention, the signal correction unit according to the second or third aspect may include a filter which is configured to remove a signal having a level equal to or higher than a defined level from the detection signal of the sensor determined to be abnormal.

With such a configuration, the filter can correct the detection signal of the sensor to be equal to or less than the reference value at which the shaft vibration abnormality determination unit determines that an abnormal vibration occurs in the rotary shaft.

According to a fifth aspect of the present invention, the signal correction unit according to any one of the second to fourth aspects may include a signal cut unit which is configured to cut the detection signal from the sensor which is determined to be abnormal to a defined level or less.

With such a configuration, the signal cut unit can correct the detection signal of the sensor to be equal to or less than the reference value at which the shaft vibration abnormality determination unit determines that an abnormal vibration occurs in the rotary shaft.

According to a sixth aspect of the present invention, the shaft vibration monitoring system according to any one of the second to fifth aspects may include an alarm output unit which is configured to output an alarm signal of a device abnormality when the shaft vibration abnormality determination unit determines that an abnormal vibration occurs in the rotary shaft. With such a configuration, when the shaft vibration abnormality determination unit determines that an abnormal vibration occurs in the rotary shaft, the operation can be stopped promptly by transmitting the device abnormality to an operator.

According to a seventh aspect of the present invention, the sensor abnormality determination unit according to any one of the first to sixth aspects may determine whether an abnormality occurs in at least one of the plurality of sensors by comparing timings of fluctuations occurring in detection signals from the plurality of sensors.

With such a configuration, when the fluctuation in the detection signals in another sensor does not exceed a certain level, if the fluctuation in the detection signals of one or more sensors among the plurality of sensors is large, it is possible to determine that an abnormality occurs in a sensor having a large fluctuation.

According to an eighth aspect of the present invention, the plurality of sensors according to any one of the first to seventh aspects may be disposed at intervals in a circumferential direction around the axis of the rotary shaft.

With such a configuration, when an abnormality occurs in at least one of the plurality of sensors disposed at intervals in the circumferential direction, the occurrence of the sensor abnormality can be detected by the sensor abnormality determination unit.

According to a ninth aspect of the present invention, the plurality of sensors according to any one of the first to eighth aspects may be disposed at positions different from each other in the direction of the axis of the rotary shaft.

With such a configuration, when an abnormality occurs in at least one of the plurality of sensors disposed at intervals in the direction of the axis, the occurrence of the sensor abnormality can be detected by the sensor abnormality determination unit.

According to a tenth aspect of the present invention, the sensor according to any one of the first to ninth aspects may be provided on each of a first side and a second side of the bearing in the direction of the axis.

According to an eleventh aspect of the present invention, the sensor according to the first or second aspect may be provided on each of the first side and the second side of the bearing in the direction of the axis. The shaft vibration monitoring unit may exclude a detection signal of the sensor determined to be abnormal among detection signals of the plurality of sensors.

In this way, it is possible to monitor the vibration of the rotary shaft using only the detection signal of the sensor in which no abnormality occurs among the plurality of sensors provided on the first side and the second side of the bearing.

According to a twelfth aspect of the present invention, when the sensor abnormality determination unit determines that an abnormality occurs in one of sensor on the first and second sides of the bearing, the shaft vibration monitoring unit according to the tenth or eleventh aspect may monitor the vibration of the rotary shaft using the detection signal of the other sensor.

In this way, even when an abnormality occurs on one of sensors on the first and second sides, it is possible to suppress a decrease in the number of measurement points by using the detection signal of the other sensor in which no abnormality occurs. Therefore, the vibration monitoring of the rotary shaft can be continued in a state in which the vibration mode can be detected with high accuracy.

According to a thirteenth aspect of the present invention, a shaft vibration monitoring system is a shaft vibration monitoring system of a rotary machine equipped with a rotary shaft and a bearing rotatably supporting the rotary shaft around an axis of the rotary shaft. The shaft vibration monitoring system includes a sensor unit, and a shaft vibration abnormality determination unit. The sensor unit has a sensor on each of a first side and a second side of the bearing in a direction of the axis. The sensor detects vibration of the rotary shaft. The shaft vibration abnormality determination unit determines whether an abnormal vibration occurs in the rotary shaft on the basis of a detection signal output from the sensor unit.

With the configurations of the tenth and thirteenth aspects, the sensors are disposed on each of the first side and the second side with the bearing sandwiched therebetween in the direction of the axis. Therefore, when an abnormality occurs in one of the sensors on the first and second sides in the direction of the axis, the detection of vibration of the rotary shaft can be continued by the other sensor of the sensors on the first and second sides in the direction of the axis.

According to a fourteenth aspect of the present invention, a rotary machine includes the shaft vibration monitoring system according to any one of the first to thirteenth aspects, a rotary shaft, and a bearing rotatably supporting the rotary shaft around an axis of the rotary shaft.

In such a rotary machine, the operating rate can be enhanced by providing the shaft vibration monitoring system.

According to the shaft vibration monitoring system and the rotary machine, the operating rate of the rotary machine can be enhanced.

### BRIEF DESCRIPTION OF THE DRAWINGS

FIG. 1 is a schematic diagram showing an overall configuration of a shaft vibration monitoring system and a rotary machine according to a first embodiment of the present invention.

FIG. 2 is a diagram showing the arrangement of a plurality of sensors constituting the shaft vibration monitoring system according to the first embodiment from a direction of the axis of the rotary shaft.

FIG. 3 is a diagram showing a plurality of sensors constituting the shaft vibration monitoring system according to the first embodiment.

FIG. 4 is a diagram showing a hardware configuration of a shaft vibration monitoring device in the shaft vibration monitoring system according to the first embodiment.

FIG. 5 is a functional block diagram of the shaft vibration monitoring device in the shaft vibration monitoring system according to the first embodiment.

FIG. 6 is a diagram showing an example of a detection signal for determining whether an abnormality occurs in the sensor, in the shaft vibration monitoring device of the shaft vibration monitoring system according to the first embodiment.

FIG. 7 is a diagram showing another example of a detection signal for determining whether an abnormality occurs in the sensor, in the shaft vibration monitoring device of the shaft vibration monitoring system according to the first embodiment.

FIG. 8 is a diagram showing an example of a case in which a detection signal front the sensor is corrected by a filter when an abnormality occurs in the sensor, in the shaft vibration monitoring device of the shaft vibration monitoring system according to the first embodiment.

FIG. 9 is a diagram showing an example of a case in which a detection signal from the sensor is corrected by a signal cut unit when an abnormality occurs in the sensor, in the shaft vibration monitoring device of the shaft vibration monitoring system according to the first embodiment.

FIG. 10 is a flowchart of a method for monitoring the sensor in the shaft vibration monitoring device of the shaft vibration monitoring system according to the first embodiment.

FIG. 11 is a schematic diagram showing an overall configuration of a shaft vibration monitoring system and a rotary machine according to a second embodiment.

FIG. 12 is a diagram showing a plurality of sensors constituting the shaft vibration monitoring system according to the second embodiment.

### DETAILED DESCRIPTION OF THE INVENTION

Hereinafter, a shaft vibration monitoring system and a rotary machine according to an embodiment of the present invention will be described on the basis of the drawings. In this embodiment, a case in which the rotary machine is a steam turbine will be described as an example.

### First Embodiment

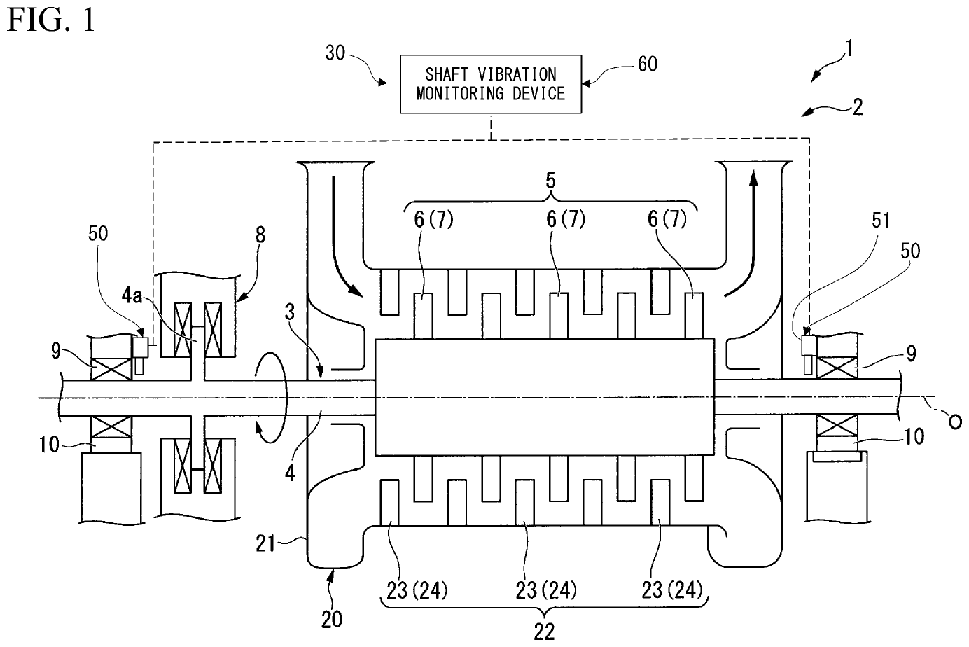

FIG. 1 is a schematic diagram showing an overall configuration of the shaft vibration monitoring system and the rotary machine according to the first embodiment.

As shown in FIG. 1, a steam turbine system 1 of this embodiment is equipped with a steam turbine 2 (a rotary machine) and a shaft vibration monitoring system 30.

The steam turbine 2 is an external combustion engine that extracts energy of steam as rotational power, and is used, for example, for a generator or the like in a power plant. The steam turbine 2 is equipped with a rotor 3, a thrust bearing 8, a journal bearing 9 (bearing), a bearing stand 10, and a stator 20.

The rotor 3 is equipped with a rotary shaft 4 and a rotor blade row group 5.

The rotary shaft 4 has a cylindrical shape centered on an axis O extending in a horizontal direction. A thrust collar 4a is formed in a part of the rotary shaft 4. The thrust collar 4a has a disk shape centered on the axis O, and protrudes integrally outward in the radial direction of the rotary shaft 4 from a main body of the rotary shaft 4 to form a flange shape.

The rotor blade row group 5 is constituted by a plurality of rotor blade rows 6 provided on an outer periphery of the rotary shaft 4 at intervals in the direction of the axis O. Each rotor blade row 6 is constituted by a plurality of rotor blades 7 extending outward in the radial direction from an outer peripheral surface of the rotary shaft 4 arranged at intervals in a circumferential direction. That is, each rotor blade row 6 is constituted by a plurality of rotor blades 7 provided radially at the same position in the direction of the axis O of the rotary shaft 4.

The thrust bearing 8 supports a thrust collar 4a to be slidable from both sides in the direction of the axis O. This restricts the movement of the rotary shaft 4 in the direction of the axis O.

The journal bearings 9 are disposed at two places at intervals in the direction of the axis O. The journal bearings 9 are supported at both end portions of the rotary shaft 4 to be rotatable around the axis O. The journal bearings 9 are supported by the bearing stand 10. A pivot is fixed to an inner peripheral surface of the bearing stand 10. A bearing pad is supported by the bearing stand 10 via such a pivot. Another member such as a guide ring may be provided inside the bearing stand 10.

The stator 20 is equipped with a casing 21 and a stator vane row group 22.

The casing 21 is provided to surround a part of the rotor 3 from the outer peripheral side. The aforementioned rotary shaft 4 of the rotor 3 penetrates the casing 21 in the direction of the axis O. With this penetration, both ends of the rotary shaft 4 are located outside the casing 21. Both ends of the rotary shaft 4 disposed outside the casing 21 are supported by the thrust bearing 8 and the journal bearing 9. The rotor blade row group 5 of the rotor 3 is disposed inside the casing 21.

The stator vane row group 22 is constituted by a plurality of stator vane rows 23 provided at intervals in the direction of the axis O. Each stator vane row 23 is equipped with a plurality of stator vanes 24 extending inward in the radial direction from the inner peripheral surface of the casing 21. The plurality of stator vanes 24 are arranged at intervals in the circumferential direction. That is, each stator vane row 23 is constituted by a plurality of stator vanes 24 radially provided at the same position in the direction of the axis O of the rotary shaft 4. The stator vane rows 23 are arranged alternately with the rotor blade rows 6 of the rotor 3 in the direction of the axis O.

In such a steam turbine 2, the steam introduced into the casing 21 passes through a flow path between the stator vane row 23 and the rotor blade row 6. Due to the passage of the steam, heat energy of the steam is converted into rotational energy, and the rotary shaft 4 rotates. The rotational energy is transmitted to a machine such as a generator connected to the rotary shaft 4.

Next, the shaft vibration monitoring system 30 of this embodiment will be described.

The shaft vibration monitoring system 30 is equipped with a sensor unit 50 and a shaft vibration monitoring device 60.

The sensor unit 50 is attached to the bearing stand 10 of the journal bearing 9. Each sensor unit 50 includes a plurality of sensors 51. The plurality of sensors 51 detect vibration of the rotary shaft 4. In this embodiment, a set of sensor units 50 is provided for each journal bearing 9.

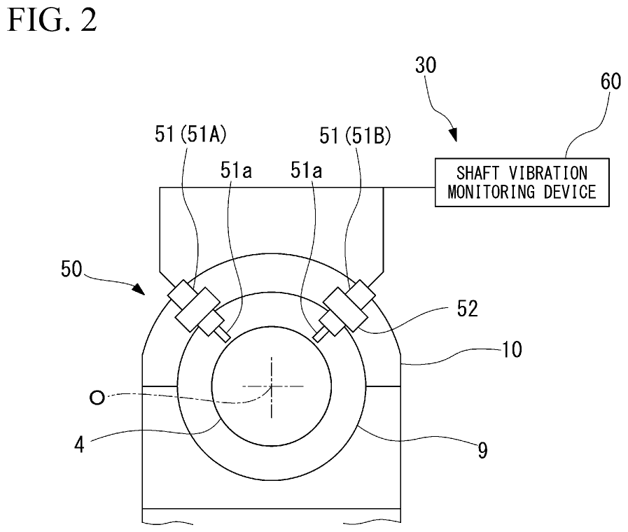

FIG. 2 is a diagram showing an arrangement of a plurality of sensors constituting the shaft vibration monitoring system according to the first embodiment, as viewed from the direction of the axis of the rotary shaft.

As shown in FIG. 2, the plurality of sensors 51 are disposed around the rotary shaft 4. Specifically, the plurality of sensors 51 are disposed at intervals in the circumferential direction around the axis O. In this embodiment, a case in which two sensors 51 of each sensor unit 50 are provided for each journal bearing 9 is shown. The sensors 51 are disposed at an opening angle of, for example, 90° about the axis O. The opening angle between the plurality of sensors 51 included in one sensor unit 50 may be other than 90°.

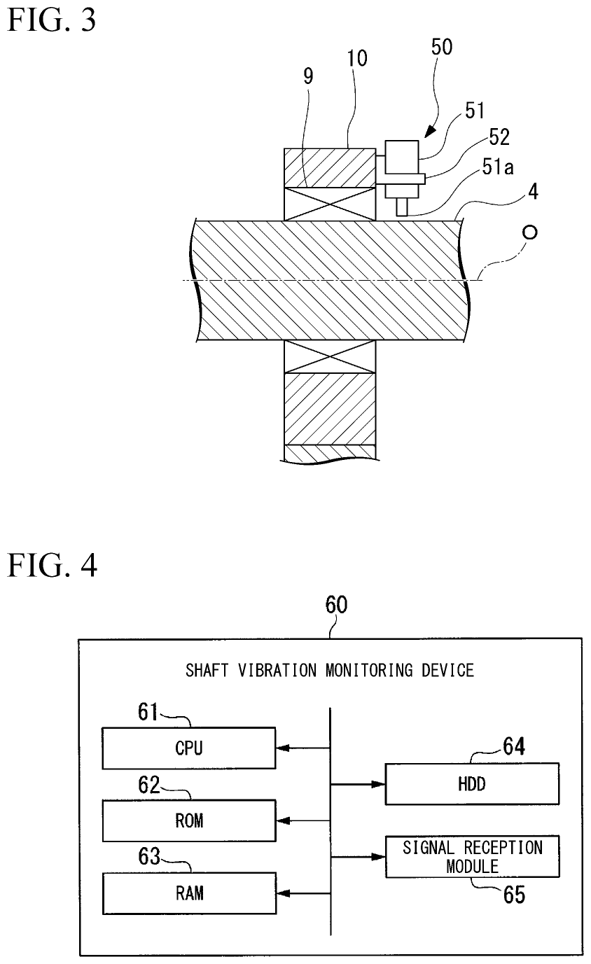

FIG. 3 is a diagram showing a plurality of sensors constituting the shaft vibration monitoring system according to the first embodiment.

As shown in FIG. 3, each sensor 51 is fixed to the bearing stand 10 of the journal bearing 9 via a bracket 52. A sensor detection unit 51a is provided at the tip of each sensor 51. The sensor detection units 51a are disposed to be close to the outer peripheral surface of the rotary shaft 4. The sensor 51 provided as an exemplary example in this embodiment is an eddy current type gap sensor, and the sensor detection unit 51a of the sensor 51 is disposed to be close to the outer peripheral surface of the rotary shaft 4. The detection signal of the sensor 51 fluctuates depending on the fluctuation in the eddy current occurring between the sensor detection unit 51a and the outer peripheral surface of the rotary shaft 4. The detection signals of each sensor 51 are transmitted to the shaft vibration monitoring device 60.

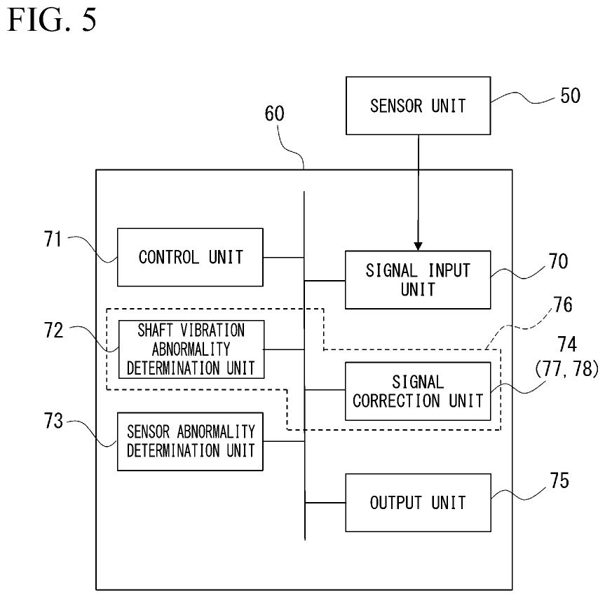

FIG. 4 is a diagram showing a hardware configuration of the shaft vibration monitoring device in the shaft vibration monitoring system according to the first embodiment. FIG. 5 is a functional block diagram of the shaft vibration monitoring device in the shaft vibration monitoring system according to the first embodiment.

As shown in FIG. 4, a shaft vibration monitoring device 60 is a computer equipped with a central processing unit (CPU) 61, a read only memory (ROM) 62, a random access memory (RAM) 63, an hard disk drive (HDD) 64, and a signal reception module 65. The signal reception module 65 receives a detection signal from each sensor 51.

As shown in FIG. 5, the CPU 61 of the shaft vibration monitoring device 60 executes a program stored in an own device in advance, thereby realizing each functional configuration of a signal input unit 70, a control unit 71, a shaft vibration abnormality determination unit 72, a sensor abnormality determination unit 73, a signal correction unit 74 and an output unit 75. The shaft vibration monitoring unit 76 is constituted by the shaft vibration abnormality determination unit 72 and the signal correction unit 74.

The signal input unit 70 is a signal reception module 65 in hardware, and receives a detection signal front each sensor 51.

The control unit 71 controls other functional units included in the shaft vibration monitoring system 30.

The shaft vibration monitoring unit 76 monitors the vibration of the rotary shaft 4.

The shaft vibration abnormality determination unit 72 determines whether abnormal vibration occurs on the rotary shaft 4 on the basis of the detection signals from the plurality of sensors 51 received by the signal input unit 70. The shaft vibration abnormality determination unit 72 determines that abnormal vibration occurs on the rotary shaft 4, when vibration of a predetermined level or more is detected in the rotary shaft 4 on the basis of the detection signal from the sensor 51. When the shaft vibration abnormality determination unit 72 determines that abnormal vibration occurs in the rotary shaft 4, the control unit 71 is able to stop the operation of the steam turbine 2.

The sensor abnormality determination unit 73 determines whether an abnormality occurs in the plurality of sensors 51 on the basis of detection signals from the plurality of sensors 51. The sensor abnormality determination unit 73 compares the detection signals to be output from the plurality of sensors 51, and determines whether an abnormality occurs in at least one of the plurality of sensors 51. For example, the sensor abnormality determination unit 73 determines whether an abnormality occurs in at least one of the plurality of sensors 51, by comparing the timings of the fluctuations occurring in the detection signals from the plurality of sensors 51.

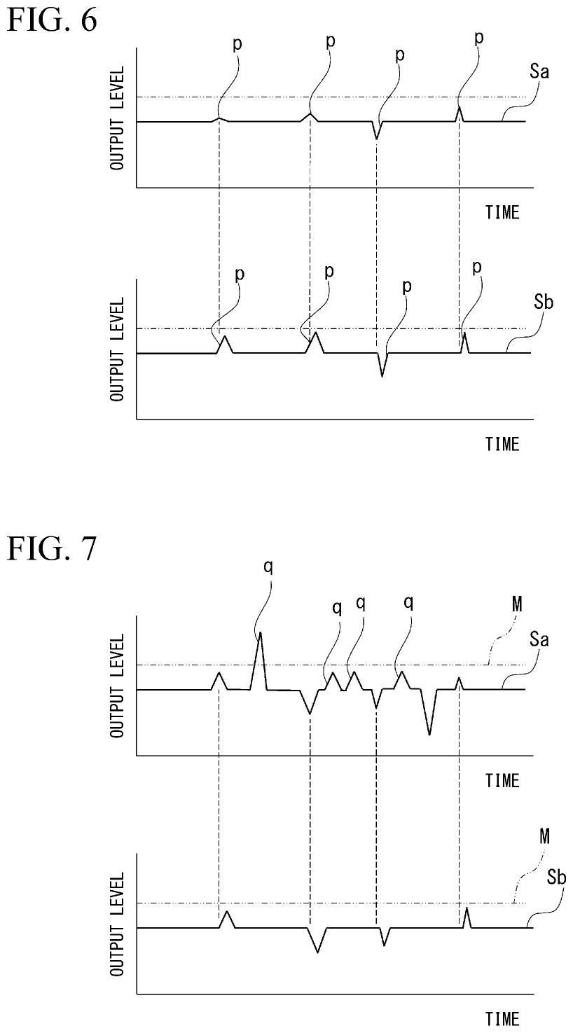

FIG. 6 is a diagram showing an example of a detection signal for determining whether an abnormality occurs in the sensor, in the shaft vibration monitoring device of the shaft vibration monitoring system according to the first embodiment.

The sensor abnormality determination unit 73 compares a detection signal Sa from a first sensor 51A (see FIG. 2) of the sensor unit 50 with a detection signal Sb from a second sensor 51B (see FIG. 2). For example, as shown in FIG. 6, at the detection signal Sa and the detection signal Sb, when the timing at which the fluctuation p of the output level occurs is shifted by the time from when the rotating rotary shaft 4 passes through the first sensor 51A to when it passes through the second sensor 51B, the sensor abnormality determination unit 73 determines that both the first sensor 51A and the second sensor 51B are operating normally. At this time, the output signals of the detection signals Sa and Sb may be different between the first sensor 51A and the second sensor 51B, depending on a mounting direction with respect to the rotary shaft 4 or the like. However, since the timing at which the fluctuation p occurs is almost simultaneous, the sensor abnormality determination unit 73 determines that the first sensor 51A and the second sensor 51B are operating normally.

FIG. 7 is a diagram showing another example of a detection signal for determining whether an abnormality occurs on the sensor, in the shaft vibration monitoring device of the shaft vibration monitoring system according to the first embodiment.

For example, as shown in FIG. 7, when only one of the detection signal Sa and the detection signal Sb has a fluctuation q of the output level in which timings are not synchronized, the sensor abnormality determination unit 73 determines that an abnormality occurs in the first sensor 51A which is configured to output the detection signal Sa including the fluctuation q.

The signal correction unit 74 corrects the detection signal of the sensor 51 that is determined to be abnormal, when the sensor abnormality determination unit 73 determines that an abnormality occurs in at least one of the plurality of sensors 51. The signal correction unit 74 outputs the corrected detection signal to the shaft vibration abnormality determination unit 72. Specifically, the signal correction unit 74 corrects the detection signal of the sensor 51 determined to be abnormal so that the detection signal is equal to or less than a reference value M (a threshold value). Here, the reference value M is a threshold value of an output level at which the shaft vibration abnormality determination unit 72 determines that abnormal vibration occurs in the rotary shaft 4. That is, when the detection signal is corrected by the signal correction unit 74 to be equal to or less than the reference value M, the shaft vibration abnormality determination unit 72 to which the corrected detection signal is input does not determine that abnormal vibration occurs on the rotary shaft 4.

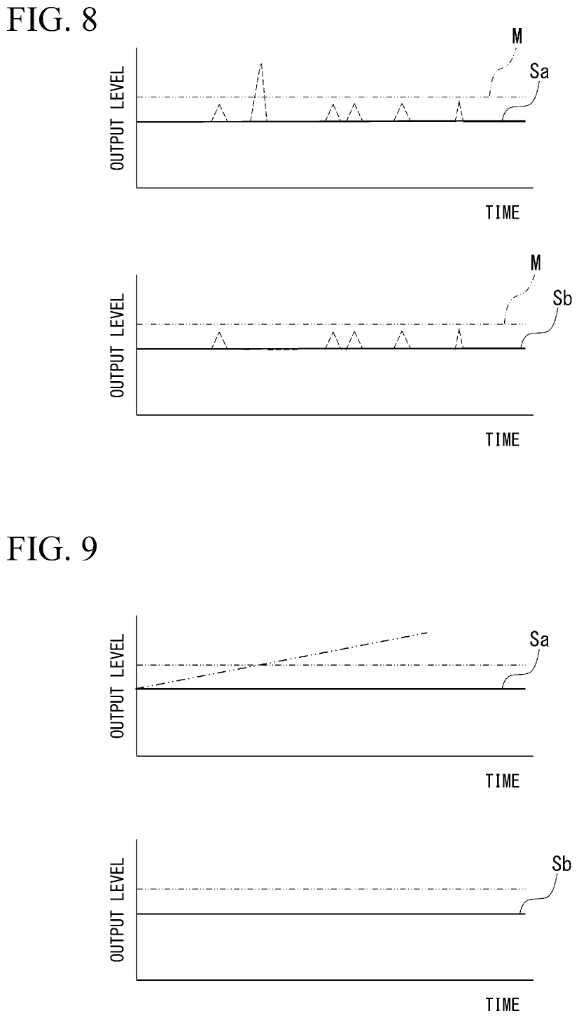

FIG. 8 is a diagram showing an example of a case in which a detection signal from the sensor is corrected by a filter when an abnormality occurs in the sensor, in the shaft vibration monitoring device of the shaft vibration monitoring system according to the first embodiment.

As such a signal correction unit 74, for example, a filter 77 (see FIG. 5) such as a notch filter can be used.

As shown in FIG. 8, the filter 77 removes a signal (for example, a spike noise, etc.) that is equal to or higher than a predetermined level, from a detection signal (for example, the detection signal Sa of the first sensor 51A) of the sensor 51 determined to be abnormal. In this way, since the filter 77 corrects the signal from the sensor 51, which is determined to be abnormal due to the superposition of spike-like noise, the detection signal is corrected to be equal to or less than the reference value M.

A notch filter is a filter circuit that attenuates only a specific frequency band of the signal to a very low level. The spike noise generated in the sensor signal is often mixed with a power supply noise. When a notch filter is used as the filter 77, by setting the power supply frequency (50 Hz or 60 Hz) as a removal frequency, noise of the frequency ranges can be reduced by the notch filter.

FIG. 9 is a diagram showing an example of a case in which a detection signal from the sensor is corrected by a signal cut unit, when an abnormality occurs in the sensor in the shaft vibration monitoring device of the shaft vibration monitoring system according to the first embodiment. As the signal correction unit 74, for example, a signal cut unit 78 (see FIG. 5) such as a DC cut can be used.

As shown in FIG. 9, when only the output of the first sensor 51A gradually increases while the output of the second sensor 51B is substantially flat, it is determined that an abnormality occurs in the first sensor 51A. If the gradual increase in the output of the first sensor 51A is due to an increase in the DC component, it is possible to cut the increase in the DC component and correct the output to a flat output, by the DC cut filter constituting the signal cut unit 78. The DC cut filter is a type of high-pass filter, and can be configured by a circuit in which a capacitor is combined with a resistor. In this manner, by correcting the signal from the sensor 51, in which an abnormality such as an increase in DC components occurs, with the signal cut unit 78, the detection signal is corrected to be equal to or less than the reference value M. Further, the filter 77 and the signal cut unit 78 may be used in combination.

The output unit 75 outputs the determination results of the shaft vibration abnormality determination unit 72 and the sensor abnormality determination unit 73 to the outside. For example, when the shaft vibration abnormality determination unit 72 determines that abnormal vibration having a level equal to or higher than the level defined for the rotary shaft 4 occurs, the output unit 75 outputs a signal for stopping the operation to a controller (not shown) of the steam turbine 2. Further, when the sensor abnormality determination unit 73 determines that an abnormality occurs in the sensor 51, the output unit 75 outputs information (for example, lighting of an alarm lamp, and warning of a contact signal for an alarm sound output) indicating that an abnormality occurs in the sensor 51 to the outside.

Next, a method for monitoring the plurality of sensors 51 using the shaft vibration monitoring device 60 will be described.

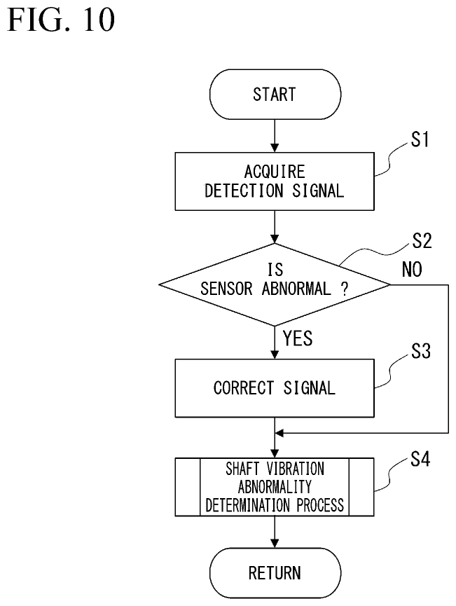

FIG. 10 is a flowchart of a method for monitoring the sensor in the shaft vibration monitoring device of the shaft vibration monitoring system according to the first embodiment.

As shown in FIG. 10, when the operation of the steam turbine 2 is started, the shaft vibration monitoring device 60 acquires detection signals that are output from the plurality of sensors 51 of the sensor unit 50 (step S1).

Next, the sensor abnormality determination unit 73 determines whether an abnormality occurs in the plurality of sensors 51 on the basis of the detection signals from the plurality of sensors 51 (step S2). For example, the sensor abnormality determination unit 73 compares the detection signals acquired from the plurality of sensors 51, and determines whether the fluctuation in the detection signal at which timing is not synchronized between the plurality of sensors 51 occurs in at least one of the plurality of sensors 51. Further, for example, the sensor abnormality determination unit 73 may determine whether the detection signal of one of the plurality of sensors 51 clearly differs from the detection signal of the other sensor 51.

When the sensor abnormality determination unit 73 determines that an abnormality occurs in at least one of the plurality of sensors 51 (“YES” in step S2), the signal correction unit 74 corrects the detection signal of the sensor 51 determined to be abnormal (step S3).

Specifically, the signal correction unit 74 corrects the detection signal of the sensor 51, which is determined to be abnormal, to be equal to or less than the reference value M (a threshold value). The corrected detection signal is input to the shaft vibration abnormality determination unit 72. That is, it is not determined that abnormal vibration occurs in the rotary shaft 4 due to the sensor abnormality. Thus, even when an abnormality occurs in the sensor 51, the operation of the steam turbine 2 can be continued as it is.

On the other hand, when it is determined that no abnormality occurs in all the plurality of sensors 51 (“NO” in step S2), the detection signal of the sensor 51 that is input to the signal input unit 70 is input to the shaft vibration abnormality determination unit 72.

The shaft vibration abnormality determination unit 72 performs a process of the shaft vibration abnormality determination on the basis of the input detection signal (step S4), and repeats the aforementioned series of processes (return). When the shaft vibration is determined to be abnormal in the shaft vibration abnormality determination process performed by the shaft vibration abnormality determination unit 72, for example, the control unit 71 stops the operation of the steam turbine 2.

According to the first embodiment described above, the sensor abnormality determination unit 73 compares the detection signals that are output from the plurality of sensors 51 and can determine whether an abnormality occurs in at least one of the plurality of sensors 51. Therefore, there is no need to unnecessarily stop the operation of the steam turbine 2 by the sensor abnormality. Therefore, the operating rate of the steam turbine 2 can be enhanced.

In the aforementioned first embodiment, when it is determined that an abnormality occurs in the sensor 51, the signal correction unit 74 can correct the detection signal of the sensor 51 that is determined to be abnormal. Thus, it is possible to reduce the possibility that the shaft vibration abnormality determination unit 72 erroneously determines that abnormal vibration occurs in the rotary shaft 4 due to the fluctuation in the detection signal caused by the abnormality of the sensor 51.

In the aforementioned first embodiment, the signal correction unit 74 can correct the detection signal of the sensor 51, which is determined to be abnormal, to be equal to or less than the reference value M at which the shaft vibration abnormality determination unit 72 determines that abnormal vibration occurs in the rotary shaft 4. Therefore, the detection signal of the sensor 51 determined to be abnormal becomes equal to or less than the reference value M, and the shaft vibration abnormality determination unit 72 is prevented from erroneously determining that abnormal vibration occurs in the rotary shaft 4 due to the fluctuation in the detection signal caused by the abnormality of the sensor 51.

In the aforementioned first embodiment, the filter 77 and the signal cut unit 78 can correct the detection signal of the sensor 51 to be equal to or less than the reference value M, at which the shaft vibration abnormality determination unit 72 determines that abnormal vibration occurs in the rotary shaft 4. Therefore, even if there is an abnormality such as an occurrence of the spike noise or an increase in the DC component, the detection signal of the sensor 51 can be set to be equal to or less than the reference value M.

In the aforementioned first embodiment, in a state in which the fluctuation in the detection signals of one or more of the plurality of sensors 51 is large and the fluctuation in the detection signal of another sensor 51 does not exceed a certain level, it is possible to determine that an abnormality occurs in the sensor 51 having a large fluctuation.

In the aforementioned first embodiment, the plurality of sensors 51 are disposed at intervals in the circumferential direction around the axis O of the rotary shaft 4. Therefore, when an abnormality occurs in at least one of the plurality of sensors 51 disposed at intervals in the circumferential direction, an occurrence of abnormality in the sensor 51 can be detected by the sensor abnormality determination unit 73.

### Second Embodiment

Next, a second embodiment of the shaft vibration monitoring system and the rotary machine according to the present invention will be described. In the second embodiment to be described below, since only a configuration of a sensor unit is different from that of the first embodiment, the same parts as those in the first embodiment are denoted by the same reference numerals, and repeated description will not be provided.

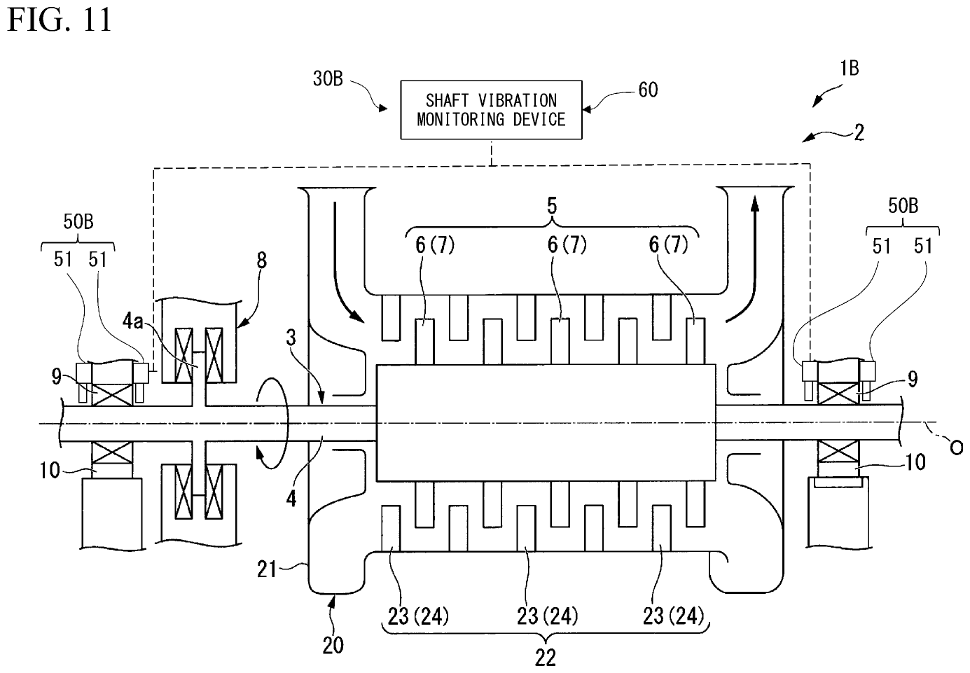

As shown in FIG. 11, a steam turbine system 1B is equipped with a steam turbine 2 (a rotary machine) and a shaft vibration monitoring system 30B.

The shaft vibration monitoring system 30B is equipped with a sensor unit 50B and a shaft vibration monitoring device 60.

The sensor units 50B are mounted on the bearing stands 10 of the journal bearings 9, respectively. In the sensor unit 50B, a plurality of sensors 51 are provided at two or more positions separated from each other within a range of a dimension defined in the direction of the axis O. Specifically, the sensor unit 50B of the second embodiment is equipped with a plurality of sensors 51 on a first side in the direction of the axis O and a second side in the direction of the axis O on the basis of the journal bearing 9, respectively. Here, in each sensor unit 50B, an interval at which the plurality of sensors 51 are separated from each other in the direction of the axis O may be, for example, about a width dimension of the bearing stand 10 in the direction of the axis.

On the first side in the direction of the axis O and the second side in the direction of the axis O of the journal bearing 9, the plurality of sensors 51 are disposed at intervals in the circumferential direction around the axis O of the rotary shaft 4 in the same manner as in the first embodiment. Further, in the second embodiment, the sensor 51 disposed on the first side in the direction of the axis O of the journal bearing 9 in the direction of the axis O and the sensor 51 disposed on the second side in the direction of the axis O are disposed at the positions symmetrical in the direction of the axis O on the basis of the journal bearing 9.

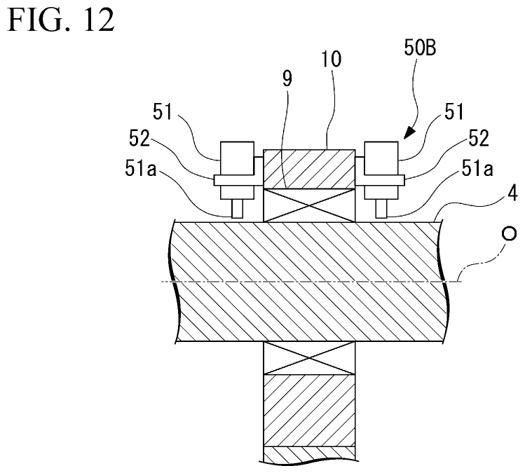

FIG. 12 is a diagram showing a plurality of sensors constituting the shaft vibration monitoring system according to the second embodiment.

As shown in FIG. 12, at each of the first side of the journal bearing 9 in the direction of the axis O and the second side in the direction of the axis O, each sensor 51 is fixed to the bearing stand 10 of the journal bearing 9 via a bracket 52. Each of the sensors 51 is disposed such that a sensor detection unit 51a provided at the tip thereof is in sliding contact with or close to the outer peripheral surface of the rotary shaft 4. The detection signal in each sensor 51 is transmitted to the shaft vibration monitoring device 60 at predetermined minute intervals.

The shaft vibration monitoring device 60 may have the same configuration as that described in the first embodiment. In this case, when an abnormality occurs in any one of the plurality (two) of sets of sensors 51 provided on one of the journal bearings 9 the output signal from the sensor 51 in which an abnormality occurs may be corrected as in the aforementioned first embodiment.

If an abnormality occurs in any one of the plurality (two) of sets of sensors 51 provided in each journal bearing 9, a detection signal from the sensor 51 in which an abnormality occurs may not be used in the shaft vibration abnormality determination unit 72 to determine whether abnormal vibration occurs in the rotary shaft 4 (in other words, excluded). Even in such a case, a sensor 51 in which no abnormality occurs remains in the two sets of sensor units 50 provided in each journal bearing 9. Further, a sensor 51 in which no abnormality occurs remains on an opposite side (the other side) of the journal bearing 9 to the side (one side) on which the sensor 51 in which an abnormality occurs is provided. Therefore, since a decrease in the number of measurement points can be suppressed, using the detection signals of the plurality of sensors 51 in which no abnormality occurs, the vibration mode can be detected with high accuracy.

According to the shaft vibration monitoring system 30B of the aforementioned second embodiment, by providing each of a plurality of sensors 51 at different positions in the direction of the axis O, when an abnormality occurs in the sensor 51 of the sensor unit 50B, if an abnormality occurs in all the plurality of other sensors 51 at different positions in the direction of the axis O, the detection of the vibration of the rotary shaft 4 can be continued, while maintaining sufficient accuracy. Further, if the replacement work of the sensor 51 in which the abnormality occurs is performed while continuing the detection by the other sensor 51, there is no need to stop the steam turbine 2 for replacement of the sensor 51. Therefore, the operating rate of the steam turbine 2 can be enhanced. In addition, when all the sensors 51 are normal, since the vibration of the rotary shaft 4 can be detected at a plurality of positions different in the direction of the axis, more accurate vibration detection can be performed.

In the second embodiment, the sensor 51 is fixed to the surface of the bearing stand 10 facing the one side in the direction of the axis O and the surface facing the other side in the direction of the axis O via the bracket 52, respectively. Therefore, two sets of sensors 51 can be easily installed for each journal bearing 9.

### Other Modified Example

The present invention is not limited to the aforementioned embodiments, and includes various modifications of the above-described embodiment without departing from the spirit of the present invention. That is, the specific shapes, configurations, and the like described in the embodiments are merely examples, and can be appropriately changed.

For example, although the example in which the present invention is applied to the steam turbine 2 has been described in the embodiment, the present invention may be applied to, for example, another rotary machine such as a gas turbine.

Further, although the case in which the number of sensors 51 provided on one side of the journal bearing 9 in the direction of the axis O is the same as the number of sensors 51 provided on the other side in the direction of the axis O has been described in the second embodiment, the number is not limited to the same case.

Furthermore, in the second embodiment, the shaft vibration monitoring unit 76 (the shaft vibration abnormality determination unit 72 and the signal correction unit 74) may be omitted.

### EXPLANATION OF REFERENCES

1, 1B Steam turbine system
2 Steam turbine (rotary machine)
3 Rotor
4 Rotary shaft
4a Thrust collar
5 Rotor blade row group
6 Rotor blade row
7 Rotor blade
8 Thrust bearing
9 Journal bearing
10 Bearing stand
20 Stator
21 Casing
22 Stator vane row group
23 Stator vane row
24 Stator vane
30, 30B Shaft vibration monitoring system
50, 50B Sensor unit
51 Sensor
51A First sensor
51B Second sensor
51a Sensor detection unit
52 Bracket
60 Shaft vibration monitoring device
61 CPU
62 ROM
63 RAM
64 HDD
65 Signal reception module
70 Signal input unit
71 Control unit
72 Shaft vibration abnormality determination unit
73 Sensor abnormality determination unit
74 Signal correction unit
75 Output unit
76 Shaft vibration monitoring unit
77 Filter
78 Signal cut unit
M Reference value
O Axis
Sa, Sb Detection signal

What is claimed is:

1. A shaft vibration monitoring system of a rotary machine equipped with a rotary shaft and a bearing rotatably supporting the rotary shaft around an axis of the rotary shaft, the shaft vibration monitoring system comprising:
a plurality of sensors which are configured to detect vibration of the rotary shaft;
a sensor abnormality determination unit which is configured to compare detection signals output from the plurality of sensors and determine whether an abnormality occurs in at least one of the plurality of sensors; and
a shaft vibration monitoring unit which is configured to monitor vibration of the rotary shaft on the basis of detection signals output from the plurality of sensors and a determination result of the sensor abnormality determination unit.

2. The shaft vibration monitoring system according to claim 1, wherein
the shaft vibration monitoring unit includes:
a shaft vibration abnormality determination unit which is configured to determine whether an abnormal vibration occurs in the rotary shaft on the basis of detection signals output from the plurality of sensors; and
a signal correction unit which is configured to correct a detection signal of the sensor determined to abnormal when the sensor abnormality determination unit determines that an abnormality occurs in at least one of the plurality of sensors.

3. The shaft vibration monitoring system according to claim 2, wherein
the signal correction unit is configured to correct the detection signal of the sensor which is determined to be abnormal to be equal to or less than a reference value at which the shaft vibration abnormality determination unit determines that an abnormal vibration occurs in the rotary shaft.

4. The shaft vibration monitoring system according to claim 2, wherein
the signal connection unit includes a filter which is configured to remove a signal having a level equal to or higher than a defined level from the detection signal of the sensor determined to be abnormal.

5. The shaft vibration monitoring system according to claim 2, wherein
the signal correction unit includes a signal cut unit which is configured to cut the detection signal from the sensor which is determined to be abnormal to a defined level or less.

6. The shaft vibration monitoring system according to claim 2, further comprising:
an alarm output unit which is configured to output an alarm of a device abnormality when the shaft vibration abnormality determination unit is configured to determine that an abnormal vibration occurs in the rotary shaft.

7. The shaft vibration monitoring system according to claim 1, wherein
the sensor abnormality determination unit is configured to determine whether an abnormality occurs in at least one of the plurality of sensors by comparing timings of fluctuations occurring in detection signals from the plurality of sensors.

8. The shaft vibration monitoring system according to claim 1, wherein
the plurality of sensors are disposed at intervals in a circumferential direction around the axis of the rotary shaft.

9. The shaft vibration monitoring system according to claim 1, wherein
the plurality of sensors are disposed at positions different from each other in a direction of the axis of the rotary shaft.

10. The shaft vibration monitoring system according to claim 1, wherein
the sensor is provided on each of a first side and a second side of the bearing in a direction of the axis.

11. The shaft vibration monitoring system according to claim 1, wherein
the sensor is provided on each of a first side and a second side of the bearing in a direction of the axis, and
the shaft vibration monitoring unit excludes a detection signal of the sensor determined to be abnormal among detection signals of the plurality of sensors.

12. The shaft vibration monitoring system according to claim 11, wherein,
when the sensor abnormality determination unit determines that an abnormality occurs in one of the sensors on the first and second sides of the bearing, the shaft vibration monitoring unit monitors the vibration of the rotary shaft using the detection signal of the other sensor.

13. A shaft vibration monitoring system of a rotary machine equipped with a rotary shaft and a bearing rotatably supporting the rotary shaft around an axis of the rotary shaft, the shaft vibration monitoring system comprising:
a sensor unit having a sensor which are configured to detects vibration of the rotary shaft on each of a first side and a second side of the bearing in a direction of the axis; and
a shaft vibration abnormality determination unit which is configured to determine whether an abnormal vibration occurs in the rotary shaft on the basis of a detection signal output from the sensor unit.

14. A rotary machine comprising:
the shaft vibration monitoring system according to claim 1;
a rotary shaft; and
a bearing rotatably supporting the rotary shaft around an axis of the rotary shaft.

15. A rotary machine comprising:
the shaft vibration monitoring system according to claim 13;
a rotary shaft; and
a bearing rotatably supporting the rotary shaft around an axis of the rotary shaft.
